(19) United States
(12) Patent Application Publication
(10) Pub. No.: US 2010/0076801 A1
(43) Pub. Date: Mar. 25, 2010

(54) ELECTRONIC COMMERCE SYSTEM AND METHOD FOR PREVENTING FRAUDULENT MERCHANDISE

(75) Inventor: Young Bae Ku, Seoul (KR)

Correspondence Address: SCHMEISER, OLSEN & WATTS, 22 CENTURY HILL DRIVE, SUITE 302, LATHAM, NY, 12110, US

(73) Assignee: eBay GMARKET Co., Ltd., Seoul (KR)

(21) Appl. No.: 12/545,100

(22) Filed: Aug. 21, 2009

(30) Foreign Application Priority Data
Sep. 23, 2008 (KR) 10-2008-0093105

(51) Int. Cl. G06Q 30/00; G06Q 50/00; G06Q 10/00

(52) U.S. Cl. 705/7; 705/26; 726/7

(57) ABSTRACT

An electronic commerce system and method for preventing fraudulent merchandise are provided. An online market server determines whether merchandise is fraudulent using real owner information when information on merchandise including real-owner terminal information is input from a seller terminal to request to register the merchandise. The merchandise requested for registration in an online market can be provided to a buyer only when the merchandise is not fraudulent by determining whether the merchandise is fraudulent, such that the buyer is provided with reliable information on merchandise and electronic commerce can be activated.

### CROSS-REFERENCE TO RELATED APPLICATION

This application claims priority to and the benefit of Korean Patent Application No. 2008-0093105, filed on Sep. 23, 2008, the disclosure of which is incorporated herein by reference in its entirety.

### BACKGROUND

1. Field of the Invention

The present invention relates to an online open market, and more particularly, to a method and system for preventing fraudulent merchandise in electronic commerce.

2. Discussion of Related Art

In recent years, the growth of online open markets has been prominent. An online open market refers to a three-dimensional shopping mall that provides an online shopping space for a direct transaction between sellers and buyers on the Internet. As such online transactions become more common, goods or services for sale are increasing.

However, even in some special fields having long histories, e.g., used-car sale businesses, online transactions have not been activated. In order to activate the online transactions, websites related to used-car sales seek new schemes, such as a system for delivering information on things such as car defects, a system for delivering information on car accidents through computerized management, and a safe payment system.

For example, a system and method for providing information on used cars for sale is disclosed in Korean Patent Laid-open Publication No. 2004-80743, in which used car sale stores in a country manage information on their cars for sale in one integrated cars-for-sale information server, such that daily changing information on used cars for sale in each store can be collected in real time and nationwide information on used cars for sale can be provided as information that can be processed and searched, through the Internet, irrespective of an information distribution time and a regional range.

Despite such efforts a used car sale market on the Internet has not been activated. When used car sales are performed on the Internet, buyers will not purchase used cars on the Internet because the information on merchandise is not reliable. For example, even if a buyer declares, online or offline, his or her intention to purchase a used car searched through the Internet, the used car may be fraudulently registered for sale by a broker or may have been sold already.

Although efforts to solve this type of problem have been disclosed in Korean Patent Laid-open Publication No. 2004-13976, this relates to real-estate trade, not to used cars.

### SUMMARY OF THE INVENTION

The present invention is directed to a system and method for preventing fraudulent merchandise for sale on the Internet. In particular, the present invention is directed to a system and method capable of providing reliable used car trade on the Internet.

According to an aspect of the present invention, there is provided an electronic commerce system for brokering online trade between a seller and a buyer, the system including an online market server for determining whether merchandise is fraudulent by transmitting information for requesting a real-owner terminal to verify that the merchandise is desired to be registered and receiving a response to the request, when information on merchandise including real-owner terminal information is input from a seller terminal to request to register the merchandise.

The online market server may interwork with an authentication-authority server to verify whether the information on the merchandise delivered upon requesting to register the merchandise is correct and to determine whether the information on the merchandise upon requesting to register the merchandise has been changed, at uniform time intervals.

According to another aspect of the present invention, there is provided an electronic commerce method for brokering online trade between a seller and a buyer, the method including: inputting information on merchandise including real owner information from a seller terminal to an online market server to request the online market server to register merchandise; and determining, by the online market server, whether the merchandise is fraudulent based on the real owner information.

According to still another aspect of the present invention, there is provided a recording medium having a computer-readable program recorded thereon for performing the electronic commerce method.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates an online market system for electronic commerce according to an exemplary embodiment of the present invention;

FIG. 2 is a flowchart illustrating an electronic commerce method for preventing fraudulent merchandise according to an exemplary embodiment of the present invention; and

FIG. 3 is a flowchart illustrating an electronic commerce method for preventing fraudulent merchandise according to another exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

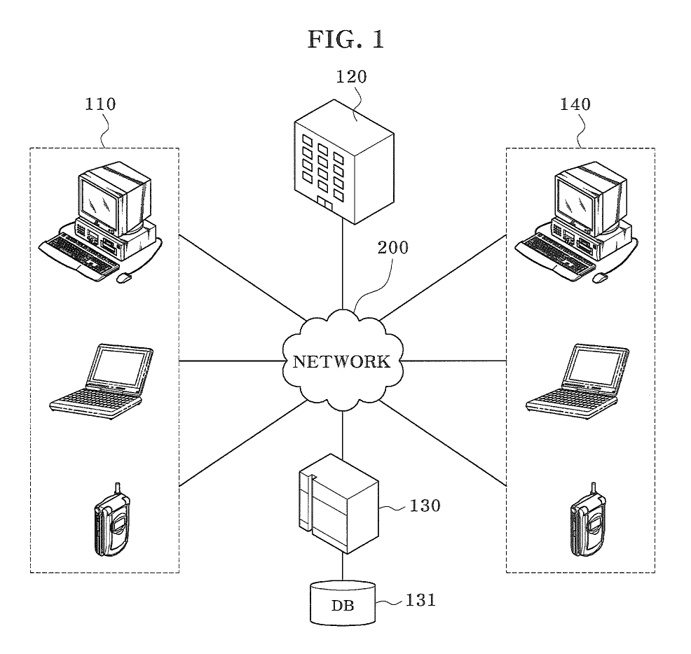

FIG. 1 illustrates an electronic commerce system for preventing fraudulent merchandise according to an exemplary embodiment of the present invention.

Referring to FIG. 1, an electronic commerce system may include a buyer terminal 110, an authentication-authority server 120, an online market server 130, a database 131, and a seller terminal 140.

When information on merchandise including real-owner terminal information is input from the seller terminal 140 to request to register merchandise, the online market server 130 determines whether the merchandise requested for registration using the real-owner terminal information is fraudulent.

In this case, the goods or services for sale may include goods or services having general brands; and goods such as domestic handiworks, returned discounted goods, secondhand goods, cooperatively purchased goods and services including mental or physical works, such as interior construction, construction, building, and legal services for which an online transaction are difficult due to characteristics of markets and goods or restrictions of related laws. Meanwhile, the present invention is more effectively applied to goods or services sold through interworking with the authentication-authority server 120, a representative example of which is used cars.

The online market server 130 may perform a payment process for an item for sale selected by the buyer from a list of items for sale, goods or services, perform an object delivery process including notifying the seller of payment information so that the item for sale can be delivered to the buyer, and provide position tracking or result inquiry service.

For example, the authentication-authority server 120 interworks with the online market server 130 through a nationwide car administration computer network. When the authentication-authority server 120 is in the nationwide car administration computer network, which manages a change in car information as up-to-date information relatively rapidly, information on fraudulent merchandise can be effectively reduced using the information, which is one characteristic of the present invention.

For example, when information on merchandise is input through the seller terminal 140, the online market server 130 uses information in the authentication-authority server 120 to determine whether the input information on the merchandise is related to fraudulent merchandise. First, the online market server 130 may determine whether the input information on the merchandise is related to fraudulent merchandise by determining whether the seller is the same as a real car owner and whether an input car owner matches the real car owner when the seller requests to sell the car through an agent, based on information such as a car number, a car owner, etc. among the input information.

Even when it is determined that the input information is not fraudulent information, the online market server 130 may continue to determine whether the merchandise has been sold, in order to reduce fraudulent merchandise or redundant merchandise. For example, the legitimately registered merchandise may be sold over time. In the case in which the merchandise has been sold, the merchandise is continuously exposed to buyers for as long as the seller does not deregister the merchandise and becomes fraudulent. To prevent this problem, the online market server 130 fetches changed information at uniform time intervals from the authentication-authority server 120 and determines whether a previously registered seller is a real car owner. In this case, when the registered car owner has been changed upon sale, which indicates that the car has been sold, the car becomes fraudulent merchandise and related sale information is deleted.

The database 131 interworking with the online market server 130 may store buyer information, seller information and basic order information, particularly in separate databases.

Both the buyer terminal 110 and the seller terminal 140 may be personal computers (PCs), notebook computers, or personal digital assistants (PDAs), but are not necessarily limited thereto. The buyer terminal 110 and the seller terminal 140 may be any of other wired or wireless communication devices that may access the online market server over a network and use bi-directional electronic commerce service.

The interworking network may be wired or wireless Internet. Alternatively, the network may be a core network integrated with a wired public network, a wireless mobile network, or mobile Internet, e.g., wireless internet platform for interoperability (WIPI) or wireless broadband internet (WiBro). The online market server 130 is a server that operates an online shopping mall over the network and brokers general sale, auction, reverse auction, negotiation, and the like for goods or services between sellers and buyers. The online market server 130 registers a variety of goods or services of the sellers received from the seller terminal 140 over the network, and provides the registered goods or services to the buyer terminal 110 over the network, so that a buyer can purchase desired goods or services.

Meanwhile, the online market server 130 is authorized by a buyer to process part or all of issuance of an auxiliary order document such as a certificate e.g., a copy of an identity card or a car registration certificate issued by an issuing authority when items for sale, goods or services requiring the auxiliary order document are requested for purchase, if necessary.

That is, the buyer provides only information for issuance of the certificate necessary for purchase of an item for sale, and the online market server 130 can obtain all auxiliary order documents which must be submitted to the seller to purchase the item for sale by requesting the issuing authority to provide the certificate online based on the information and acquiring the certificate. In this case, a scheme disclosed in the applicant's Korean Patent Application No. 2007-111440 may be used.

Meanwhile, the seller terminal 140 requests the online market server 130 to register merchandise. In this case, (1) the seller may request the online market server 130 to register his or her car and (2) the seller may request the online market server 130 to register merchandise on behalf of a real car owner. In the case of (2), a store/agent is authorized by a real car owner to sell the merchandise, in which most agents are secondhand-article sale stores, which often register fraudulent merchandise according to their business strategy.

The present invention prevents registration of fraudulent merchandise in the both cases. It is noted that the present invention includes requesting the real car owner to verify the merchandise.

First, in the case in which the seller requests the online market server 130 to register his or her car, an address of the seller will usually be the same as a personal address of a member subscribed to the online market server 130. For example, information such as a name, an address, and contact information of the member subscribed to the online market server 130 matches car owner information. In this case, once the merchandise is requested for registration, the online market server 130 requests the authentication-authority server 120 to determine whether the personal information matches the car information, receives a result of determining, and verifies whether the input information is correct.

After verifying, the online market server 130 performs authentication using input information of the real car owner. The authentication may be generally performed using any scheme using a known authentication system, such as using a cellular phone or a certificate.

Meanwhile, in the case in which the agent requests the online market server 130 to register a car for sale, a personal address of a member subscribed to the online market server 130 is different form the car owner. When the merchandise is requested for registration, the online market server 130 requests the authentication-authority server 120 to determine whether information such as a name, an address, contact information and terminal information of the real owner matches the car information in the authentication-authority server 120, receives a result of determining, and verifies whether the input information is correct, in order to determine whether the requested merchandise is fraudulent.

After verifying, the online market server 130 performs authentication using the input information of the real car owner. The authentication may be generally performed using any scheme using a known authentication system, such as using a cellular phone or a certificate.

With this scheme, it is possible to verify information on fraudulent merchandise that the agent registers without approval of the real car owner, thereby greatly reducing the fraudulent merchandise.

Meanwhile, a used car requested for registration in the above scheme is requested for purchase through the buyer terminal 110. Once the car registration is completed and then car purchase is reserved by the buyer, the car for sale may exist only in the database 131 and not be searched on the open market website provided by the online market server 120.

In another scheme, the car for sale may exist in the database 131 and be searched, but an indication indicating that “Reserved Car” may be displayed. Also, once reservation is made, next-order reservation may be disabled.

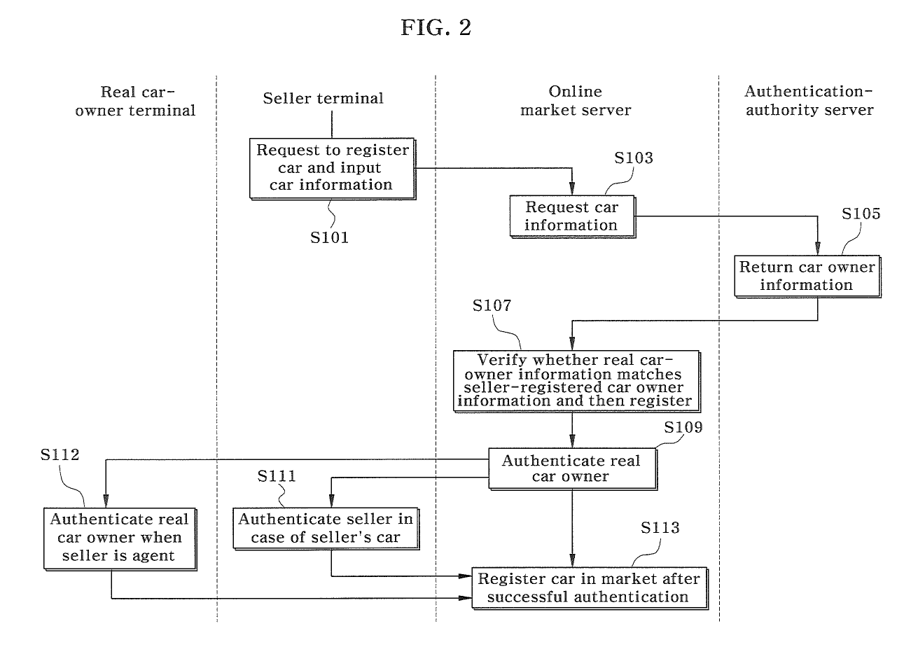

The electronic commerce method for preventing fraudulent merchandise according to the present invention will be described in detail with reference to FIGS. 1 and 2. FIG. 2 is a flowchart illustrating an electronic commerce method for preventing fraudulent merchandise according to an exemplary embodiment of the present invention.

Referring to FIGS. 1 and 2, first, the seller terminal 140 requests the online market server 130 to register merchandise (S101). Here, the car registration is requested and car information is input, in which information on a real-owner terminal of the car is input. The car registration involves basic car information, such as a car number, a car owner name, a car lot address, real-owner terminal information, and contact information, and may involve seller information. The seller information may be information input upon subscription in the online market server 130 or may be input separately. The former may be more efficient. Here, when the seller is a car owner, the seller authentication may be naturally performed through login. That is, the authentication may be performed using a member ID and a password for the online market server 130. Additionally, the authentication may be performed using a separate certificate.

Upon receipt of a request for car registration through the seller terminal 140, the online market server 130 requests the authentication-authority server 120 to provide car information such as real owner information of a car registered as merchandise (S103). In response to the request, the authentication-authority server 120 returns the car information to the online market server 130 (S105). Using the information delivered in steps S103 and S105, the online market server 130 verifies whether the seller-registered car owner matches real car owner information (S107).

This process is intended to perform registration after determining whether registration information of a car for sale registered in the online market server 130 matches the real car owner information. Without this process, it is impossible to prevent the seller registering a car from deliberately registering fraudulent car-owner information. The process can prevent fraudulent merchandise.

When it is verified in step S107 that information including the seller-registered car owner does not match the real car information, registration is not completed and when the information including the seller-registered car owner matches the real car information, the method proceeds to a next step.

In the next step, the online market server 130 authenticates the real car-owner terminal (S109). The online market server 130 performs authentication using the registered car owner information to verify whether the registered car information is information on fraudulent merchandise. The car owner may be notified of the authentication task by a text message including a short message service (SMS) message, a long message service (LMS) message, and a multimedia message service (MMS) message, or by electronic mail.

Meanwhile, different authentications may be performed (1) when the seller requests to register his or her car (S111), and (2) when the seller requests to register merchandise on behalf of a real car owner (S112). First, (1) when the seller requests to register his or her car, seller authentication may be performed through login on the online market server 130 or may be separately performed using an authentication system of Korea Investors Service Co., Ltd. Next, (2) when the seller requests to register merchandise on behalf of the real car owner, it is determined through authentication whether the seller really desires to register the merchandise, using a cellular phone number of the real car owner. It will be easily appreciated that in this process, the scheme of notifying the authentication task of the car owner by a text message including a SMS message, a LMS message, and a MMS message, or by electronic mail and requesting a response is effective, but other schemes may be used.

The verification of whether the real car owner desires to register the merchandise is one core process of determining whether the merchandise is fraudulent. In general, fraudulent merchandise is mainly utilized by an agent registering previously sold merchandise in the online market server without approval of the real car owner to induce buyers and introduce other merchandise when a buyer attempts to contact the agent. It is verified whether the real car owner desires to register the merchandise, and when the merchandise is fraudulent, the real car owner reveals that the merchandise has been sold or he or she does not want to register the merchandise, thereby reducing fraudulent merchandise.

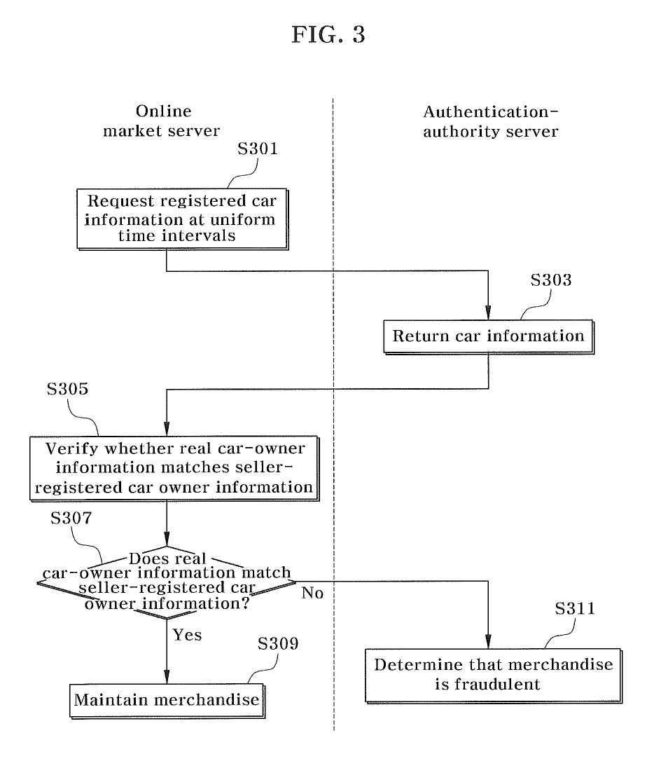

Another electronic commerce method for preventing fraudulent merchandise according to the present invention will be described with reference to FIG. 3. FIG. 3 is a flowchart illustrating an electronic commerce method for preventing fraudulent merchandise according to the present invention.

A determination is made as to whether information on merchandise registered in the online market server 130 is changed at uniform time intervals through the authentication-authority server 120. For example, the authentication-authority server 120 is managing a change in the car information as up-to-date information relatively rapidly using a nationwide car administration computer network. Accordingly, the change in the information on the merchandise can be verified by using the information input to the authentication-authority server 120. The change in the information on the merchandise is verified on occasion because the merchandise requested for registration may have been sold already. In this case, the seller deregisters the merchandise immediately, but may deliberately or accidentally fail to deregister the merchandise immediately. When the change is not updated rapidly, buyers will encounter fraudulent merchandise.

Specifically, first, the online market server 130 requests the authentication-authority server 120 to provide car information such as car owner information registered as merchandise (S301). Upon receipt of the car information, the authentication-authority server 120 delivers the requested car information to the online market server 130 (S303).

The online market server 130 determines whether input information matches the registered real car owner, based on the delivered car information (S305).

When it is determined that the input information matches the registered real car owner, the online market server 130 maintains the merchandise and otherwise, determines that the merchandise is fraudulent and deregisters the merchandise.

Meanwhile, the electronic commerce method of FIG. 3 may be performed at any uniform time intervals, which may be based on a time interval at which the authentication-authority server 120 updates information. For example, when the time interval at which the authentication-authority server 120 updates the information is one day, the online market server 130 may perform the method of FIG. 3 at time intervals of one day.

The functions used in the method and system disclosed in this specification may be implemented as computer-readable code on a computer-readable recording medium. The computer-readable recording medium may include any of all kinds of recording devices that store computer-readable data. Examples of the computer-readable recording medium include a read-only memory (ROM), a random access memory (RAM), a compact disk-read only memory (CD-ROM), a magnetic tape, a floppy disk, and optical data storage. Another example of the medium is carrier waves (e.g., Internet transmission). Further, the computer-readable recording medium may be distributed over networked computer systems so that the computer-readable code can be stored and executed in a de-centralized manner.

According to the present invention, it can be verified whether merchandise requested for registration in an online market is fraudulent, and when the merchandise requested for registration is not fraudulent, it can be provided to a buyer, such that the buyer is provided with only reliable information on merchandise. This can help to activate the electronic commerce.

It can be verified whether a real owner desires to request to register merchandise, thereby improving reliability of the merchandise.

Also, seller-input information is verified and a change in the information is periodically reflected through an authentication-authority server, thereby providing more reliable information on merchandise.

While the invention has been shown and described with reference to certain exemplary embodiments thereof, it will be understood by those skilled in the art that various changes in form and details may be made therein without departing from the spirit and scope of the invention as defined by the appended claims.

1. An electronic commerce system for brokering online trade between a seller and a buyer, the system comprising an online market server for determining whether merchandise is fraudulent by transmitting information for requesting a real-owner terminal to verify that the merchandise is desired to be registered and receiving a response to the request, when information on merchandise including real-owner terminal information is input from a seller terminal to request to register the merchandise.

2. The system of claim 1, wherein the online market server interworks with an authentication-authority server to verify whether the information on the merchandise delivered upon requesting to register the merchandise is correct.

3. The system of claim 1, wherein the online market server interworks with an authentication-authority server to determine whether the information on the merchandise upon requesting to register the merchandise has been changed, at uniform time intervals.

4. The system of claim 1, wherein the real-owner terminal is the same as from the seller terminal.

5. The system of claim 1, wherein the seller terminal requesting to register the merchandise is authenticated through login on the online market server.

6. The system of claim 1, wherein when the buyer reserves purchase, the online market server causes the merchandise to exist only in a database and not be searched on a website.

7. The system of claim 1, wherein when the buyer reserves purchase, the online market server causes the merchandise to be searched on a website, but displays an indication indicating “Reserved Car.”

8. An electronic commerce method for brokering online trade between a seller and a buyer, the method comprising:
inputting information on merchandise including real owner information from a seller terminal to an online market server to request the online market server to register merchandise; and
determining, by the online market server, whether the merchandise is fraudulent based on the real owner information.

9. The method of claim 8, further comprising determining, by the online market server, whether the information on the merchandise delivered upon requesting to register the merchandise is correct by interworking with an authentication-authority server.

10. The method of claim 8, further comprising determining, by the online market server, whether the information on the merchandise delivered upon requesting to register the merchandise has been changed at uniform time intervals by interworking with an authentication-authority server.

11. The method of claim 8, wherein the determining of whether the merchandise is fraudulent is performed by transmitting information for a verification request to a real-owner terminal and receiving a response to the request.

12. The method of claim 8, wherein the seller terminal requesting the merchandise is authenticated through login on the online market server.

13. A recording medium having a computer-readable program recorded thereon for performing a method according to claim 8.

14. The system of claim 1, wherein the real-owner terminal is different from the seller terminal.
